(19) United States
(12) Patent Application Publication
(10) Pub. No.: US 2024/0248280 A1
(43) Pub. Date: Jul. 25, 2024

(54) DRIVING MECHANISM

(71) Applicant: TDK TAIWAN CORP., Taoyuan City (TW)

(72) Inventors: Po-Xiang ZHUANG, Taoyuan City (TW); Chao-Yuan CHANG, Taoyuan City (TW); Wei-Jhe SHEN, Taoyuan City (TW); Sin-Jhong SONG, Taoyuan City (TW); Kun-Shih LIN, Taoyuan City (TW); Yi-Ho CHEN, Taoyuan City (TW); Chao-Chang HU, Taoyuan City (TW)

(21) Appl. No.: 18/417,378

(22) Filed: Jan. 19, 2024

Related U.S. Application Data
(60) Provisional application No. 63/439,983, filed on Jan. 19, 2023.

(51) Int. Cl. G02B 7/08; G02B 27/64

(52) U.S. Cl. CPC G02B 7/08; G02B 27/646

(57) ABSTRACT

A driving mechanism for moving an optical element is provided. The driving mechanism includes a fixed part, a movable part, a driving assembly, and a first guiding member. The optical element is disposed on the movable part. The driving assembly drives the movable part to move relative to the fixed par. The first guiding member is disposed between the fixed part and the movable part. The movable part is guided by the first guiding member when moving relative to the fixed part.

### CROSS REFERENCE TO RELATED APPLICATIONS

This application claims the benefit of U.S. Provisional Application No. 63/439,983, filed Jan. 19, 2023, the entirety of which is incorporated by reference herein.

### BACKGROUND OF THE INVENTION

### Field of the Invention

The present invention relates to a driving mechanism, and, in particular, to a driving mechanism for moving an optical element.

### Description of the Related Art

As technology has advanced, a lot of electronic devices (for example, laptop computers and smartphones) have incorporated the functionality of taking photographs and recording video. These electronic devices have become more commonplace, and have been developed to be more convenient and thin. More and more options are provided for users to choose from.

Some electronic devices use coils and magnets to adjust the focus of a lens. However, miniaturization of these electronic devices may increase the difficulty of mechanical design, and it may also lead to low reliability and low driving force for moving the lens. Addressing these problems has become a challenge.

### BRIEF SUMMARY OF THE INVENTION

An embodiment of the present invention provides a driving mechanism for moving an optical element. The driving mechanism includes a fixed part, a movable part, a driving assembly, and a first guiding member. The optical element is disposed on the movable part. The driving assembly drives the movable part to move relative to the fixed part. The first guiding member is disposed between the fixed part and the movable part. The movable part is guided by the first guiding member when moving relative to the fixed part.

In some embodiments, the fixed part includes a housing and a polygonal base connected to each other, the movable part is movably received in the housing, and the base has a first side, a second side, a third side, and a fourth side, wherein the first and third sides are parallel to each other, and the second and fourth sides are parallel to each other.

In some embodiments, the base has a first column, the movable part has a first recessed portion, and the first guiding member is disposed between the first column and the first recessed portion.

In some embodiments, the first recessed portion has a first contact surface and a second contact surface in contact with the first guiding member, and the first contact surface is not parallel to the second contact surface.

In some embodiments, the first and second contact surfaces are not parallel to the first and second sides of the base.

In some embodiments, the first recessed portion also has a third contact surface and a fourth contact surface in contact with the first guiding member, and the third contact surface is not parallel to the fourth contact surface.

In some embodiments, the first and second contact surfaces are in a different position then the third and fourth contact surfaces along the optical axis of the optical element.

In some embodiments, the first column has a first abutting surface and a second abutting surface in contact with the first guiding member, the first abutting surface is parallel to the second and fourth contact surfaces of the first recessed portion, and the second abutting surface is parallel to the first and third contact surfaces of the first recessed portion.

In some embodiments, the driving mechanism further includes a second guiding member, wherein the base also has a second column, and the movable part also has a second recessed portion, wherein the second guiding member is disposed between the second column and the second recessed portion.

In some embodiments, the second recessed portion has a first sidewall parallel to the first side of the base and in contact with the second guiding member.

The driving mechanism as claimed in claim 10, wherein the second recessed portion also has a second sidewall, a third sidewall, a fourth sidewall, and a fifth sidewall, the second sidewall is connected between the first and third sidewalls, and the fourth sidewall is connected between the third and fifth sidewalls.

In some embodiments, the second column has a third abutting surface and a fourth abutting surface in contact with the second guiding member, the third abutting surface is parallel to the first side of the base, and the fourth abutting surface is parallel to the second side of the base.

In some embodiments, the first and second columns are located at opposite corners of the base.

In some embodiments, at least a part of the second column is received in the second recessed portion.

In some embodiments, the first and second guiding members are longitudinal rods.

In some embodiments, the driving mechanism further includes a magnetic permeable element, wherein the driving assembly includes at least a magnet disposed on the fixed part and at least a coil disposed on the movable part, and the magnetic permeable element is disposed on a first end surface of the movable part and located between the coil and the first end surface.

In some embodiments, the movable part has a first protrusion and a second protrusion projecting from the first end surface, the coil surrounds the first and second protrusions, the first protrusion has a first lateral surface adjacent to the first end surface and angled relative to the first and second sides of the base.

In some embodiments, the movable part has a plurality of winding posts, the winding posts protrude from the movable part in an extending direction that is parallel to the first lateral surface.

In some embodiments, the second protrusion has a second lateral surface adjacent to the first end surface and parallel to the second side of the base, and the magnetic permeable element is positioned between the first and second lateral surfaces.

In some embodiments, the driving assembly includes a plurality of magnets disposed on the fixed part and a plurality of coils disposed on the movable part, and the coils are respectively disposed on the first end surface and a second end surface of the movable part, wherein a plurality of third protrusions are formed on the second end surface, one of the coils surrounds the third protrusions, and one of the third protrusions has a third lateral surface that is angled relative to the first and second sides of the base.

In some embodiments, the first and third lateral surfaces are parallel to each other.

In some embodiments, the first and third lateral surfaces have an included angle of less than 10 degrees.

In some embodiments, the magnetic permeable element has a main body and a plurality of extending portions, the main body extends along the optical axis of the optical element, and the extending portions extend from the main body in opposite directions.

In some embodiments, the magnetic permeable element has a cross-shaped structure.

### BRIEF DESCRIPTION OF THE DRAWINGS

The present invention can be more fully understood by reading the subsequent detailed description and examples with references made to the accompanying drawings, wherein:

FIG. 1 shows an exploded view of a driving mechanism 100 in accordance with an embodiment of the invention.

FIG. 2 shows another exploded view of the driving mechanism 100 in FIG. 1.

FIG. 3 shows a perspective diagram of the driving mechanism 100 in FIGS. 1 and 2.

FIG. 4 shows another perspective diagram of the driving mechanism 100 in FIGS. 1 and 2.

FIG. 5 is an exploded view showing a magnetic permeable element K disposed between the holder LH and the coil C.

FIG. 6 is a top view of the driving mechanism 100 with the housing H and a frame F omitted therefrom.

FIG. 7 is a perspective diagram showing the magnetic permeable element K when mounted on the holder LH.

FIG. 8 is another perspective diagram showing the magnetic permeable element K when mounted on the holder LH.

FIG. 9 is an enlarged view of the area A1 in FIG. 6.

FIG. 10 is an enlarged view of the area A2 in FIG. 6.

FIG. 11 is a perspective diagram of the magnetic permeable element K in FIG. 5.

### DETAILED DESCRIPTION OF THE INVENTION

The making and using of the embodiments of the driving mechanism are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

In the following detailed description of the preferred embodiments, reference is made to the accompanying drawings, and in which specific embodiments of which the invention may be practiced are shown by way of illustration. In this regard, directional terminology, such as “top,” “bottom,” “left,” “right,” “front,” “back,” etc., is used with reference to the orientation of the figures being described. The components of the present invention can be positioned in a number of different orientations. As such, the directional terminology is used for the purposes of illustration and is in no way limiting.

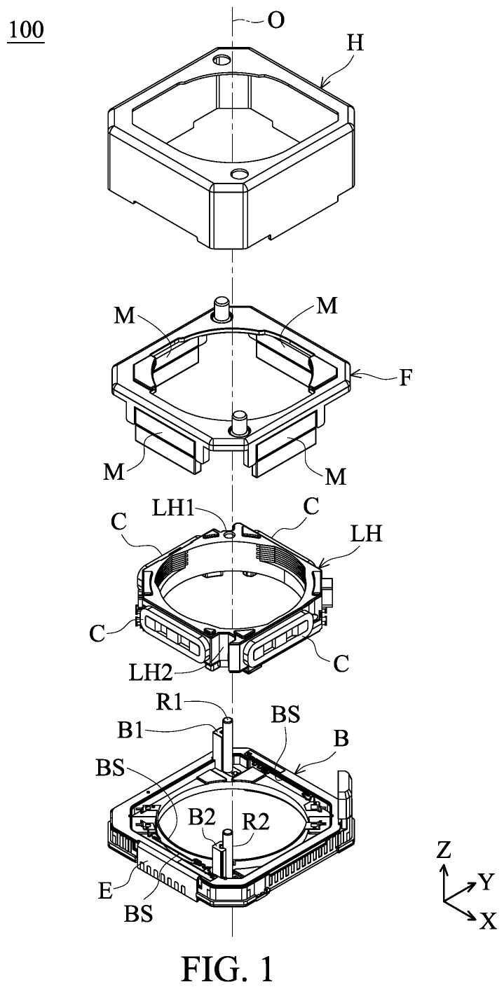

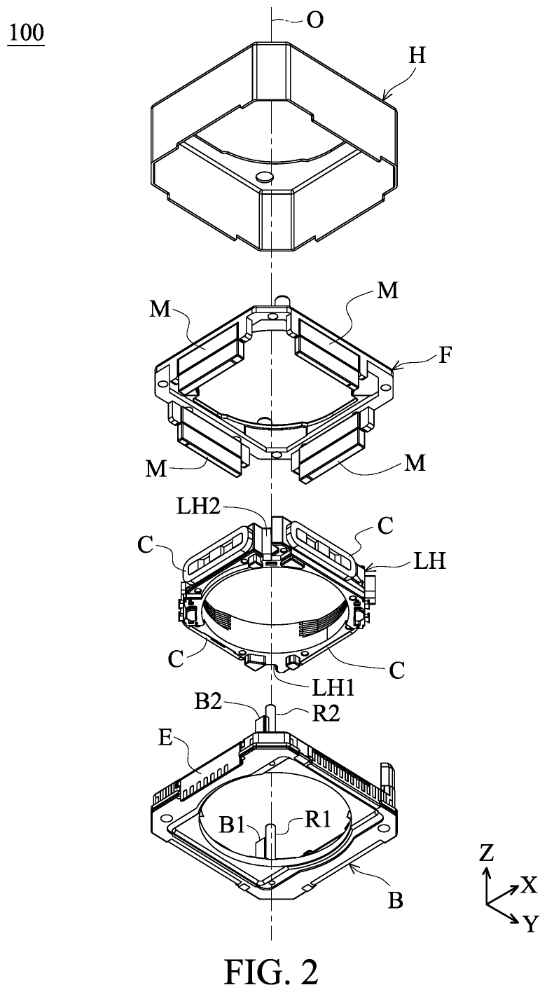

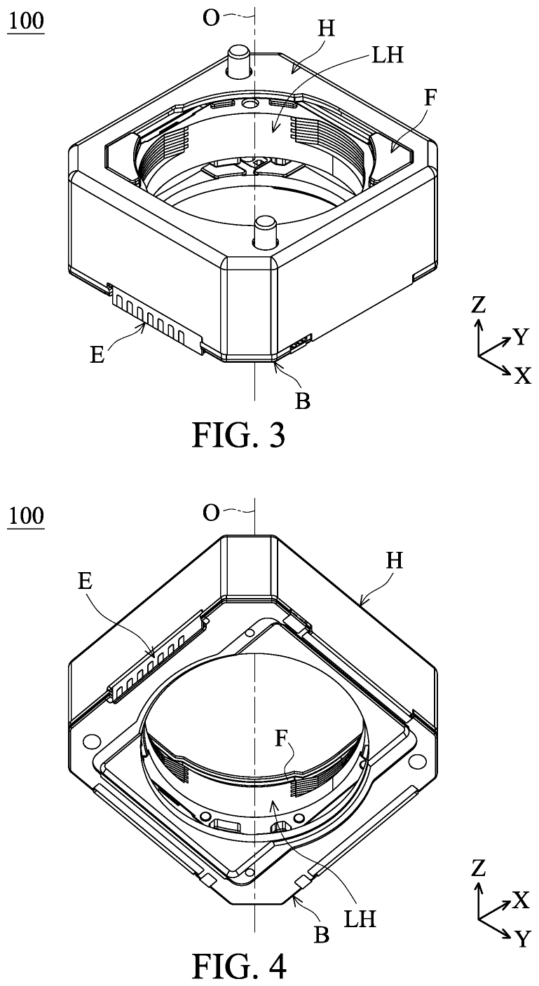

FIG. 1 shows an exploded view of a driving mechanism 100 in accordance with an embodiment of the invention. FIG. 2 shows another exploded view of the driving mechanism 100 in FIG. 1. FIG. 3 shows a perspective diagram of the driving mechanism 100 in FIGS. 1 and 2. FIG. 4 shows another perspective diagram of the driving mechanism 100 in FIGS. 1 and 2.

Referring to FIGS. 1-4, the driving mechanism 100 in this embodiment is a Voice Coil Motor (VCM) which may be disposed in a cell phone or other portable electronic device for driving an optical element (e.g. optical lens) to move, thereby achieving the function of auto-focusing (AF) or Optical Image Stabilization (OIS).

The driving mechanism 100 primarily comprises a hollow housing H, a polygonal plastic base B, a first guiding member R1, a second guiding member R2, a circuit assembly E (e.g. flexible circuit board), at least a lower sheet spring BS, a holder LH, a frame F, at least a magnetic element M, and at least a coil C.

In this embodiment, the housing H has a hollow structure affixed to the base B. Here, the housing H and the base B form a fixed part of the driving mechanism 100. The circuit assembly E is disposed on the top surface of the base B and surrounds the optical axis O of the optical element. Three lower sheet springs BS are disposed on the top surface of the base B and connected to the holder LH. The circuit assembly E can be electrically connected to the coils C via the lower sheet springs BS to form a circuit loop.

The holder LH is movably received in the housing H, and an optical element (not shown) is affixed in the holder LH. The holder LH forms a movable part that is movable relative to the fixed part (the housing H and the base B).

It should be noted that the holder LH is suspended within the driving mechanism 100 by the lower sheet springs BS connected between the base B and the holder LH. With the configuration as described above, external light can enter the driving mechanism 100 along the optical axis O of the optical element, and light can propagate through the optical element to an image sensor (not shown) below the base B to form a digital image.

The frame F is adhered to the inner surface of the housing H, and four magnetic elements M (e.g. magnets) are disposed on the four sides of the frame F. Additionally, four coils C are disposed on four sides of the holder LH and located corresponding to the magnetic elements M. The coils C and the magnetic elements M constitute a driving assembly for impelling the movable part (the holder LH) relative to the fixed part (the housing H and the base B) along the optical axis O.

When a current signal is applied to the coils C, an electromagnetic force can be generated by the coils C and the magnets M, so that the holder LH and the optical element received therein are driven to move relative to the fixed part (the housing H and the base B) along the optical axis O (Z direction). Hence, the function of auto-focusing (AF) or Optical Image Stabilization (OIS) can be achieved.

In FIG. 1, the first and second guiding members R1 and R2 are longitudinal rods affixed to the base B. The base B forms a first column B1 and a second column B2 extending along the optical axis O (Z direction). The first guiding member R1 is located at the upper-left corner of the base B and abut the first column B1. The second guiding member R2 is located at the lower-right corner of the base B and abut the second column B2. Here, the first and second columns B1 and B2 are located on opposite sides of the holder LH.

Moreover, the holder LH has a first recessed portion LH1 and a second recessed portion LH2, corresponding to the first and second guiding members R1 and R2. After assembly of the driving mechanism 100, the first guiding member R1 is connected between the first column B1 and the first recessed portion LH1, and the second guiding member R2 is connected between the second column B2 and the second recessed portion LH2.

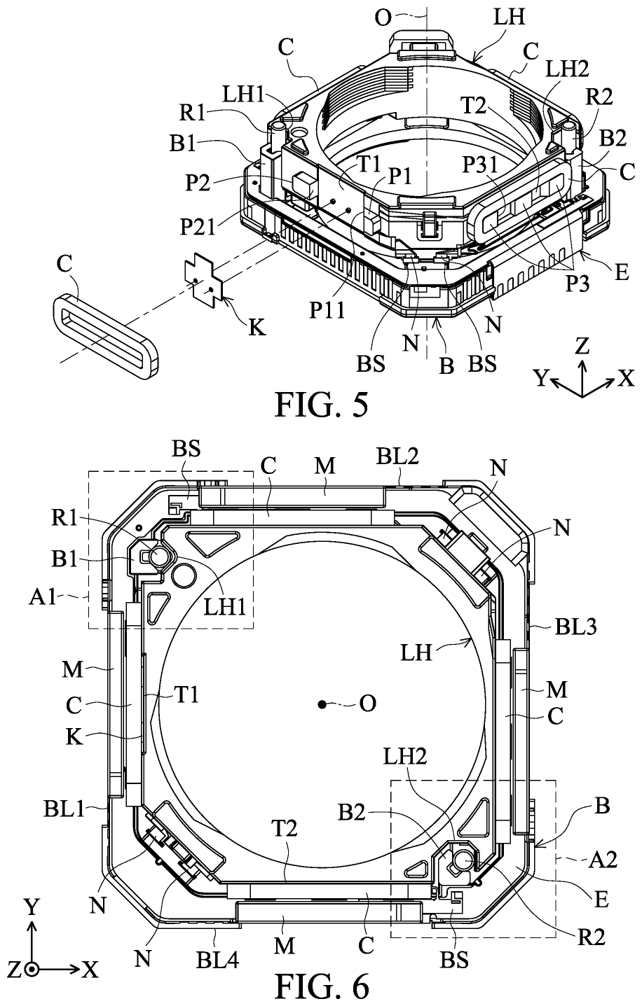

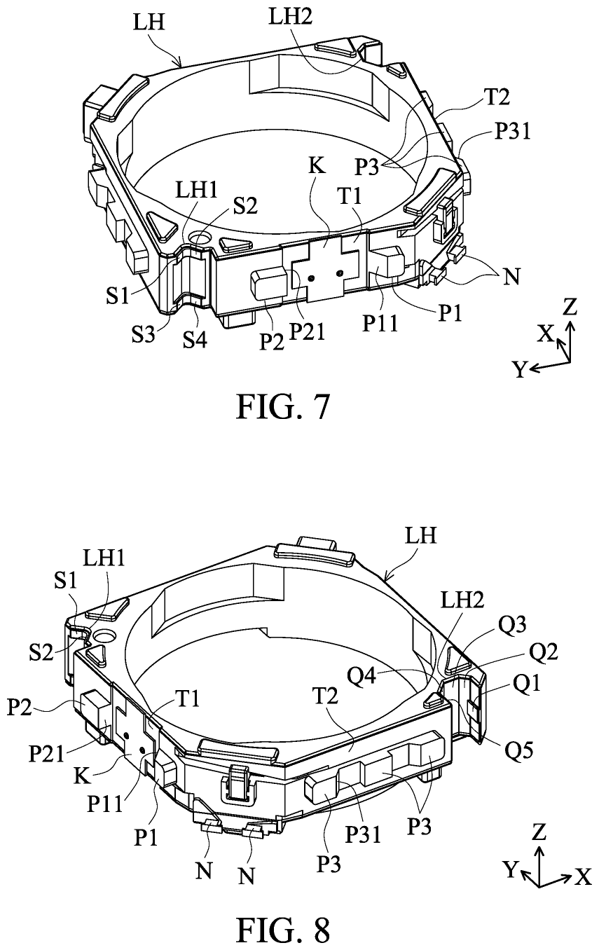

FIG. 5 is an exploded view showing a magnetic permeable element K disposed between the holder LH and the coil C. FIG. 6 is a top view of the driving mechanism 100 with the housing H and a frame F omitted therefrom. FIG. 7 is a perspective diagram showing the magnetic permeable element K when mounted on the holder LH. FIG. 8 is another perspective diagram showing the magnetic permeable element K when mounted on the holder LH.

Referring to FIG. 5, the first guiding member R1 is connected between the first column B1 and the first recessed portion LH1, and the second guiding member R2 is connected between the second column B2 and the second recessed portion LH2. Moreover, a magnetic permeable element K is disposed on a first end surface T1 of the holder LH. Here, a first protrusion P1 and a second protrusion P2 are formed on the first end surface T1. The first protrusion P1 has a first lateral surface P11, and the second protrusion P2 has a second lateral surface P21, wherein the magnetic permeable element K is positioned between the first and second lateral surfaces P11 and P21.

During assembly of the driving mechanism 100, one of the coils C is wound around the first and second protrusions P1 and P2, and the magnetic permeable element K is disposed between the coil C and the first end surface T1 of the holder LH. With the magnetic attractive force generated between the magnetic permeable element K and the magnetic element M, the first guiding member R1 can be pressed and movably connected between the first column B1 and the first recessed portion LH1. Similarly, the second guiding member R2 can be pressed and connected between the second column B2 and the second recessed portion LH2, thereby achieving precise positioning and high reliability of the driving mechanism 100.

As shown in FIG. 6, the quadrilateral base B has a first side BL1, a second side BL2, a third side BL3, and a fourth side BL4. The first and third sides BL1 and BL3 are parallel to the Y axis, and the second and fourth sides BL2 and BL4 are parallel to the X axis.

It can be seen in FIG. 6 that four winding posts N are formed on opposite corners of the holder LH. During assembly of the driving mechanism 100, one end of four wires (not shown) are wound on the winding posts N, and the other end of the wires are connected to the four coils C, respectively. The wires wound on the winding posts N can be electrically connected to the lower sheet springs BS beneath the winding posts N by soldering or welding, whereby the electrical current signal can be transferred from the circuit assembly E to the coils C through the sheet springs BS.

In this embodiment, the winding posts N protrude from the holder LH in an extending direction that is angled (e.g. about 45 degrees) relative to the first and second sides BL1 and BL2 of the base B.

Moreover, the first protrusion P1 has a first lateral surface P11 that is angled (e.g. about 45 degrees) relative to the first and second sides BL1 and BL2 of the base B. In some embodiments, the first lateral surface P11 is parallel to the extending direction of the winding posts N. The second protrusion P2 has a second lateral surface P21 that is parallel to the second and fourth sides BL2 and BL4 of the base B.

FIG. 5 further shows a plurality of third protrusions P3 formed on a second end surface T2 of the holder LH. Another coil C is disposed on the second end surface T2 and wound around the third protrusions P3. Specifically, at least one of the third protrusions P3 forms a third lateral surface P31 that is connected to the second end surface T2 and angled (e.g. about 45 degrees) relative to the first and second sides BL1 and BL2 of the base B.

In some embodiments, the first and third lateral surfaces P11 and P31 are both parallel to the extending direction of the winding posts N. However, in some embodiments, the first and third lateral surfaces P11 and P31 may have a small included angle that is less than 10 degrees.

With the first and second protrusions P1 and P2 formed on the first end surface T1, the glue can be applied in the space between the first and second protrusions P1 and P2, whereby the coil C, the magnetic permeable element K, and the holder LH can be firmly adhered to each other. Specifically, with the first lateral surface P11 of the first protrusion P1 that is angled relative to the first and second sides BL1 and BL2 of the base B, the space for accommodating the glue and the adhesion area between the holder LH and the glue can be increased, thereby enhancing the connection strength between the coil C, the magnetic permeable element K, and the holder LH.

Similarly, with the third lateral surface P31 of the third protrusions P3 that is angled relative to the first and second sides BL1 and BL2 of the base B, the adhesion area between the holder LH and the glue can be increased, whereby the coil C can be firmly affixed to the second end surface T2 of the holder LH.

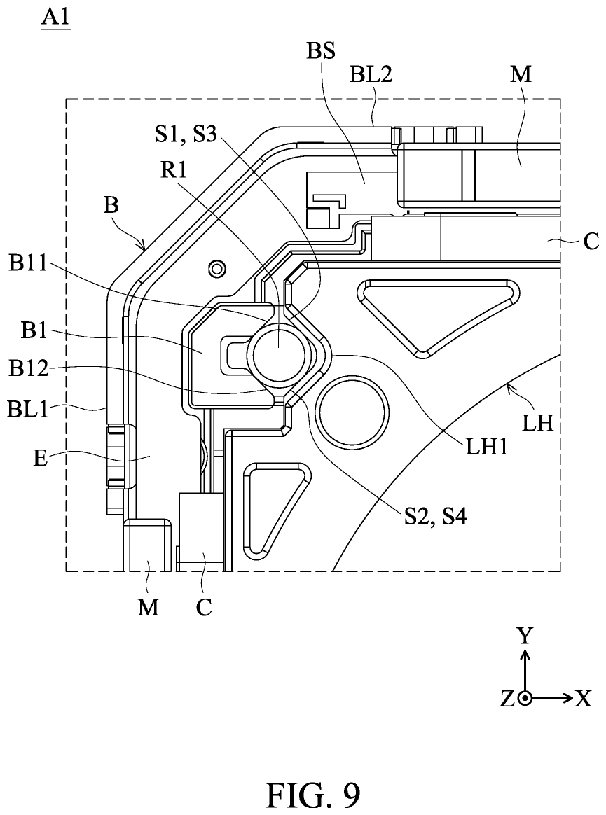

FIG. 9 is an enlarged view of the area A1 in FIG. 6. Referring to FIGS. 6, 7, and 9, the first recessed portion LH1 of the holder LH forms a V-shaped structure that has a first contact surface S1, a second contact surface S2, a third contact surface S3, and a fourth contact surface S4. The first and second contact surfaces S1 and S2 are located at the same height along the Z axis and adjacent to each other. The third and fourth contact surfaces S3 and S4 are located at the same height along the Z axis and adjacent to each other.

Here, the first and second contact surfaces S1 and S2 are higher than the third and fourth contact surfaces S3 and S4 (FIG. 7). Moreover, the first, second, third, and fourth contact surfaces S1, S2, S3, and S4 are angled relative to the first side BL1 (Y axis) and the second side BL2 (X axis) of the base B.

In this embodiment, the first and third contact surfaces S1 and S3 are angled (e.g. about 45 degrees) relative to the first side BL1 (Y axis) and the second side BL2 (X axis) of the base B. The included angle between the first and third contact surfaces S1, S3 and the second and fourth contact surfaces S2, S4 is about 90 degrees, but the invention is not limited to the embodiments depicted in the figures.

Additionally, it can be seen in FIG. 9 that the first column B1 of the base B forms a first abutting surface B11 and a second abutting surface B12 that are perpendicular to each other. The first abutting surface B11 is substantially parallel to the second and fourth contact surfaces S2, S4 of the first recessed portion LH1 of the holder LH. The second abutting surface B12 is substantially parallel to the first and third contact surfaces S1, S3 of the first recessed portion LH1 of the holder LH.

Hence, the first guiding member R1 can be used as a hinge that is pressed and connected between the first and second abutting surfaces B11, B12 of the first column B1 and the first, second, third, and fourth contact surfaces S1-S4 of the first recessed portion LH1 of the holder LH. Therefore, the holder LH can be driven to move along the first guiding member R1 relative to the base B in the Z direction, and it can also rotate relative to the base B within a small range around the first guiding member R1.

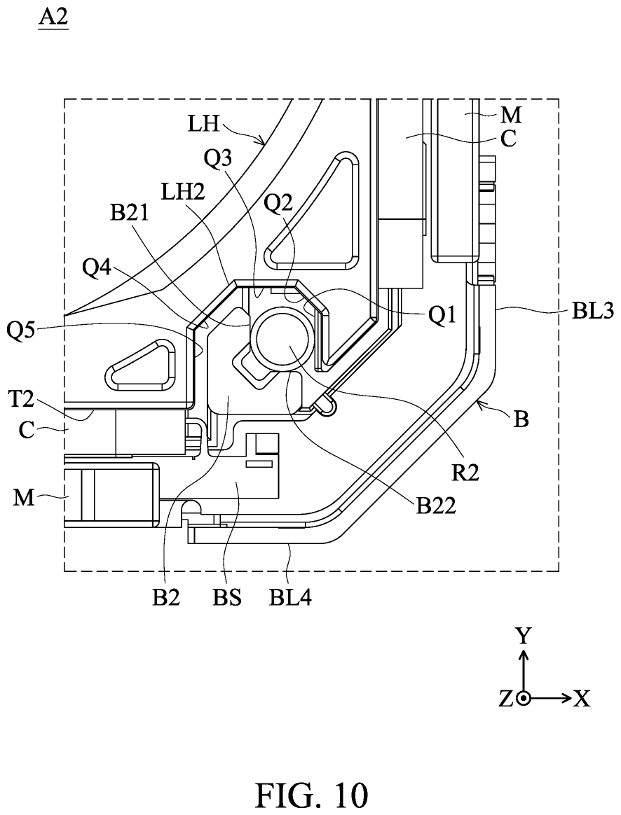

FIG. 10 is an enlarged view of the area A2 in FIG. 6. Referring to FIGS. 6, 8, and 10, the second recessed portion LH2 of the holder LH forms a polygonal space for accommodating at least a part of the second column B2 and the second guiding member R2. In this embodiment, the second recessed portion LH2 has a first sidewall Q1, a second sidewall Q2, a third sidewall Q3, a fourth sidewall Q4, and a fifth sidewall Q5. The first and fifth sidewalls Q1 and Q5 are substantially parallel to the first and third sides BL1 and BL3 (Y axis) of the base B. The third sidewall Q3 is substantially parallel to the second and fourth sides BL2 and BL4 (X axis) of the base B. The second sidewall Q2 is connected between the first and third sidewalls Q1 and Q3, and the fourth sidewall Q4 is connected between the third and fifth sidewalls Q3 and Q5.

As shown in FIG. 10, the first, second, third, fourth, and fifth sidewalls Q1-Q5 face the second column B2 and the second guiding member R2. When the magnetic attractive force is generated between the magnetic permeable element K and the magnetic element M after assembly of the driving mechanism 100, the first sidewall Q1 of the second recessed portion LH2 of the holder LH contacts the second guiding member R2 in the-X direction. Therefore, the second guiding member R2 can be pressed and movably connected between the second column B2 and the second recessed portion LH2.

It can be seen in FIG. 10 that the second column B2 of the base B forms a third abutting surface B21 and a fourth abutting surface B22 that are perpendicular to each other. The third abutting surface B21 is substantially parallel to the first and fifth contact surfaces Q1, Q5 of the second recessed portion LH1 of the holder LH. The fourth abutting surface B22 is substantially parallel to the third contact surfaces Q3 of the second recessed portion LH2 of the holder LH.

When a current signal is applied to the coils C, an electromagnetic force can be generated by the coils C and the magnets M, and the holder LH and the optical element received therein can be driven to move in the Z or-Z direction along the first and second guiding members R1 and R2, whereby the function of auto-focusing (AF) or Optical Image Stabilization (OIS) can be achieved.

In this embodiment, as the second, third, fourth, and fifth sidewalls Q2-Q5 are spaced apart from the second column B2 and the second guiding member R2, the friction between the holder LH and the second guiding member R2 when sliding can be reduced, thus improving the performance of the driving mechanism.

With the configuration described above, the first guiding member R1 can be used as a hinge between the base B and the holder LH to facilitate smooth rotation and sliding of the holder LH with respect to the base B. Moreover, as the second guiding member R2 is pressed and connected between the second column B2 and the holder LH, stable and smooth sliding of the holder LH relative to the base B along the Z axis can be achieved. Additionally, mechanical interference between the coils C and the first and second columns B1 and B2 of the base B can be prevented, and the size of the driving mechanism 100 can also be reduced.

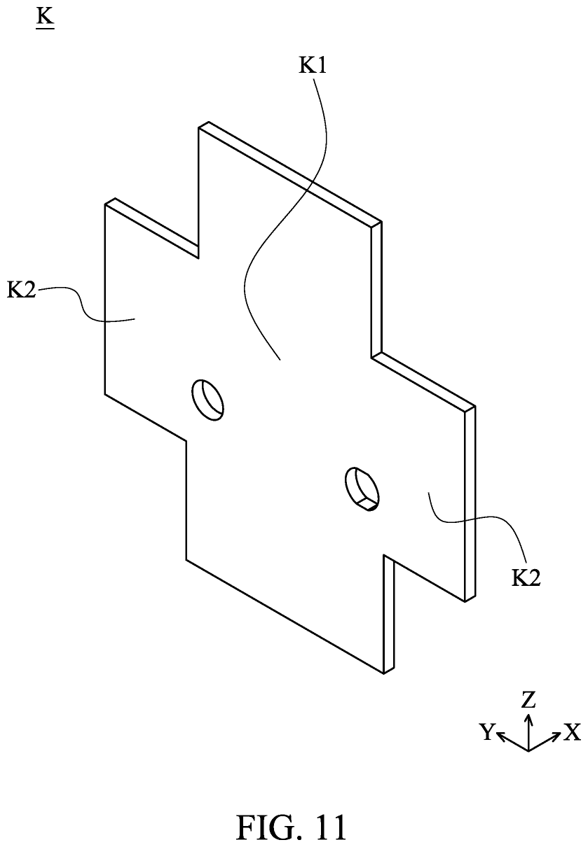

FIG. 11 is a perspective diagram of the magnetic permeable element K in FIG. 5. Referring to FIG. 11, the magnetic permeable element K in this embodiment may be a metal sheet that has a cross-shaped structure. The magnetic permeable element K primarily includes a main body K1 and at least two extending portions K2 connected to the main body K1. The main body K1 extends along the optical axis O (Z direction), and the extending portions K2 are located on opposite side of the main body K1. In this embodiment, one of the extending portions K2 extends from the left side of the main body K1 in the Y direction, and the other extending portions K2 extends from the right side of the main body K1 in the-Y direction.

With the structure of the extending portions K2, the magnetic attraction area between the magnetic permeable element K and the magnetic element M in the Y and-Y directions can be increased, thus improving the stability of the movable part LH when moving relative to the base B along the Z axis.

When the magnetic attractive force is generated between the cross-shaped magnetic permeable element K and the magnetic element M after assembly of the driving mechanism 100, the first guiding member R1 can be stably pressed and connected between the first column B1 of the base B and the first recessed portion LH1 of the holder LH, and the second guiding member R2 can be stably pressed and connected between the second column B2 of the base B and the second recessed portion LH2 of the holder LH, thereby achieving precise positioning and high reliability of the driving mechanism 100.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification.

As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A driving mechanism for moving an optical element, the driving mechanism comprising:
a fixed part;
a movable part, wherein the optical element is disposed on the movable part;
a driving assembly, driving the movable part to move relative to the fixed part; and
a first guiding member, disposed between the fixed part and the movable part, wherein the movable part is guided by the first guiding member when moving relative to the fixed part.

2. The driving mechanism as claimed in claim 1, wherein the fixed part includes a housing and a polygonal base connected to each other, the movable part is movably received in the housing, and the base has a first side, a second side, a third side, and a fourth side, wherein the first and third sides are parallel to each other, and the second and fourth sides are parallel to each other.

3. The driving mechanism as claimed in claim 2, wherein the base has a first column, the movable part has a first recessed portion, and the first guiding member is disposed between the first column and the first recessed portion.

4. The driving mechanism as claimed in claim 3, wherein the first recessed portion has a first contact surface and a second contact surface in contact with the first guiding member, and the first contact surface is not parallel to the second contact surface.

5. The driving mechanism as claimed in claim 4, wherein the first and second contact surfaces are not parallel to the first and second sides of the base.

6. The driving mechanism as claimed in claim 4, wherein the first recessed portion further has a third contact surface and a fourth contact surface in contact with the first guiding member, and the third contact surface is not parallel to the fourth contact surface.

7. The driving mechanism as claimed in claim 6, wherein the first and second contact surfaces are in a different position from the third and fourth contact surfaces along an optical axis of the optical element.

8. The driving mechanism as claimed in claim 6, wherein the first column has a first abutting surface and a second abutting surface in contact with the first guiding member, the first abutting surface is parallel to the second and fourth contact surfaces of the first recessed portion, and the second abutting surface is parallel to the first and third contact surfaces of the first recessed portion.

9. The driving mechanism as claimed in claim 3, further comprising a second guiding member, wherein the base further has a second column, and the movable part further has a second recessed portion, wherein the second guiding member is disposed between the second column and the second recessed portion.

10. The driving mechanism as claimed in claim 9, wherein the second recessed portion has a first sidewall parallel to the first side of the base and in contact with the second guiding member.

11. The driving mechanism as claimed in claim 10, wherein the second recessed portion further has a second sidewall, a third sidewall, a fourth sidewall, and a fifth sidewall that are not in contact with the second guiding member and the second column, the second sidewall is connected between the first and third sidewalls, and the fourth sidewall is connected between the third and fifth sidewalls.

12. The driving mechanism as claimed in claim 11, wherein the second column has a third abutting surface and a fourth abutting surface in contact with the second guiding member, the third abutting surface is parallel to the first sidewall, and the fourth abutting surface is parallel to the third sidewall.

13. The driving mechanism as claimed in claim 9, wherein the first and second columns are located at opposite corners of the base.

14. The driving mechanism as claimed in claim 9, wherein at least a part of the second column is received in the second recessed portion.

15. The driving mechanism as claimed in claim 9, wherein the first and second guiding members are longitudinal rods.

16. The driving mechanism as claimed in claim 9, further comprising a magnetic permeable element, wherein the driving assembly includes a magnet disposed on the fixed part and a coil disposed on the movable part, and the magnetic permeable element is disposed on a first end surface of the movable part and located between the coil and the first end surface.

17. The driving mechanism as claimed in claim 16, wherein the movable part has a first protrusion and a second protrusion projecting from the first end surface, the coil surrounds the first and second protrusions, and the first protrusion has a first lateral surface adjacent to the first end surface and angled relative to the first and second sides of the base.

18. The driving mechanism as claimed in claim 17, wherein the movable part has a plurality of winding posts, and the winding posts protrude from the movable part in an extending direction that is parallel to the first lateral surface.

19. The driving mechanism as claimed in claim 17, wherein the second protrusion has a second lateral surface adjacent to the first end surface and parallel to the second side of the base, and the magnetic permeable element is positioned between the first and second lateral surfaces.

20. The driving mechanism as claimed in claim 17, wherein the driving assembly includes a plurality of magnets disposed on the fixed part and a plurality of coils disposed on the movable part, and the coils are respectively disposed on the first end surface and a second end surface of the movable part, wherein a plurality of third protrusions are formed on the second end surface, one of the coils surrounds the third protrusions, and one of the third protrusions has a third lateral surface that is angled relative to the first and second sides of the base.

21. The driving mechanism as claimed in claim 20, wherein the first and third lateral surfaces are parallel to each other.

22. The driving mechanism as claimed in claim 20, wherein the first and third lateral surfaces have an included angle of less than 10 degrees.

23. The driving mechanism as claimed in claim 16, wherein the magnetic permeable element has a main body and a plurality of extending portions, the main body extends along an optical axis of the optical element, and the extending portions extend from the main body in opposite directions.

24. The driving mechanism as claimed in claim 23, wherein the magnetic permeable element has a cross-shaped structure.
